(19) United States
(12) Patent Application Publication
(10) Pub. No.: US 2013/0197929 A1
(43) Pub. Date: Aug. 1, 2013

(54) HEALTHCARE COMMUNICATION SYSTEM

(71) Applicant: CareFusion 303, Inc., San Diego, CA (US)

(72) Inventors: Timothy W. Vanderveen, Poway, CA (US); Ryan Nguyen, San Diego, CA (US)

(73) Assignee: CareFusion 303, Inc., San Diego, CA (US)

(21) Appl. No.: 13/802,454

(22) Filed: Mar. 13, 2013

Related U.S. Application Data
(63) Continuation-in-part of application No. 09/860,865, filed on May 18, 2001.
Application No. 09/860,865 is a continuation-in-part of application No. 10/361,704, filed on Feb. 9, 2003.
Application No. 10/361,704 is a continuation-in-part of application No. 10/750,032, filed on Dec. 31, 2003.
Application No. 10/750,032 is a continuation-in-part of application No. 13/246,782, filed on Sep. 27, 2011.
Application No. 13/246,782 is a continuation of application No. 12/947,773, filed on Nov. 16, 2010, now Pat. No. 8,340,792.
Application No. 12/947,773 is a continuation of application No. 10/925,511, filed on Aug. 25, 2004, now Pat. No. 7,860,583.
Application No. 10/925,511 is a continuation-in-part of application No. 11/326,145, filed on Dec. 30, 2005.
Application No. 11/326,145 is a continuation-in-part of application No. 13/421,776, filed on Mar. 15, 2012.
(60) Provisional application No. 60/205,125, filed on May 18, 2000.
(60) Provisional application No. 60/652,382, filed on Feb. 11, 2005.
(60) Provisional application No. 61/555,820, filed on Nov. 4, 2011.
(60) Provisional application No. 61/453,853, filed on Mar. 17, 2011.

(51) Int. Cl. G06Q 30/00; G06Q 50/22

(52) U.S. Cl. CPC G06Q 30/01; G06Q 50/22
USPC 705/2

(57) ABSTRACT

A healthcare communication system may include a communication network along with healthcare systems and healthcare devices that are communicatively coupled to the communication network. At least one of the healthcare systems may transmit first messages that include orders for patients over the communication network to the healthcare devices. The healthcare devices facilitate providing healthcare to the patients, and transmit, to the healthcare system over the communication network and in response to receiving the first messages, second messages that indicate that the first messages comprising the orders have been received, The healthcare devices may transmit, to the healthcare system over the communication network and while the orders are being administered, third messages that each include information relating to a progress of one of the orders. The healthcare devices may further transmit, to the healthcare system over the communication network, fourth messages that indicate that the orders were administered to the patients.

### CROSS-REFERENCE TO RELATED APPLICATIONS

The present application is a continuation-in-part of co-pending U.S. patent application Ser. No. 09/860,865, entitled “Distributed Remote Asset and Medication Management Drug Delivery System,” filed on May 18, 2001, which claims priority to U.S. Provisional Patent Application Ser. No. 60/205,125, entitled “Distributed remote asset and medication management drug delivery system (DRAMMDDS),” filed on May 18, 2000, both of which are hereby incorporated by reference in their entirety for all purposes. The present application is also a continuation-in-part of co-pending U.S. patent application Ser. No. 10/361,704, entitled “Medication Management and Event Logger and Analysis System,” filed on Feb. 9, 2003, which is hereby incorporated by reference in its entirety for all purposes. The present application is also a continuation-in-part of co-pending U.S. patent application Ser. No. 10/750,032, entitled “Centralized Medication Management System,” filed on Dec. 31, 2003, which is hereby incorporated by reference in its entirety for all purposes. The present application is also a continuation-in-part of co-pending U.S. patent application Ser. No. 13/246,782, entitled “System and Method for Dynamically Adjusting Patient Therapy,” filed on Sep. 27, 2011, which is a continuation of U.S. patent application Ser. No. 12/947,773, entitled “System and Method for Dynamically Adjusting Patient Therapy,” filed on Nov. 16, 2010, now issued as U.S. Pat. No. 8,340,792, which is a continuation of U.S. patent application Ser. No. 10/925,511, entitled “System and Method for Dynamically Adjusting Patient Therapy,” filed on Aug. 25, 2004, now issued as U.S. Pat. No. 7,860,583, all of which are hereby incorporated by reference in their entirety for all purposes. The present application is also a continuation-in-part of co-pending U.S. patent application Ser. No. 11/326,145, entitled “Management of Pending Medication Orders,” filed on Dec. 30, 2005, which claims priority to U.S. Provisional Patent Application Ser. No. 60/652,382, entitled “Management of Pending Medication Orders,” filed on Feb. 11, 2005, both of which are hereby incorporated by reference in their entirety for all purposes. The present application is also a continuation-in-part of co-pending U.S. patent application Ser. No. 13/421,776, entitled “Scalable Communication System,” filed on Mar. 15, 2012, which claims priority to U.S. Provisional Patent Application Ser. No. 61/555,820, entitled “Communication Interface,” filed on Nov. 4, 2011, and also claims priority to U.S. Provisional Patent Application Ser. No. 61/453,853, entitled “Communication User Interface,” filed on Mar. 17, 2011, all of which are hereby incorporated by reference in their entirety for all purposes.

### TECHNICAL FIELD

The present description relates generally to a communication system, and more particularly, but not exclusively, to integrating systems and devices in a healthcare communication system.

### BACKGROUND

Healthcare facilities, such as hospitals, may utilize many different user devices, healthcare devices, and/or healthcare systems to facilitate with providing healthcare to patients. For example, a healthcare facility may utilize healthcare systems to facilitate with providing healthcare to patients, such as through physician order entry systems, pharmacy information systems, hospital information systems, etc. The healthcare facility may also utilize healthcare devices to facilitate with providing healthcare to patients, such as infusion devices, dispensing devices, respiratory devices, etc. In addition, the healthcare facility may utilize user devices to facilitate with providing healthcare to patients, such as computing stations that are located throughout the health facility, personal digital assistants (PDAs) that are carried by physicians, etc. However, communication barriers between these systems and/or devices may prevent the healthcare facility from providing efficient and effective healthcare to patients.

### SUMMARY

The disclosed subject matter relates to a communication system. The communication system may include a communication network and a plurality of healthcare systems communicatively coupled to the communication network, where at least one of the plurality of healthcare systems is configured to transmit first messages comprising orders for a plurality of patients over the communication network to a plurality of healthcare devices. The plurality of healthcare devices may be communicatively coupled to the communication network and are each further configured to facilitate providing healthcare to at least one of the plurality of patients, transmit, to the at least one of the plurality of healthcare systems over the communication network and in response to receiving the first messages, second messages that indicate that the first messages comprising the orders have been received, transmit, to the at least one of the plurality of healthcare systems over the communication network and while the orders are being administered, third messages that each comprise information relating to a progress of administering one of the orders, and transmit, to the at least one of the plurality of healthcare systems over the communication network, fourth messages that indicate that the orders were administered to the patients.

The disclosed subject matter also relates to a control system that includes one or more processors and a memory. The memory includes instructions that, when executed by the one or more processors, cause the one or more processors to: receive, from a plurality of healthcare systems over a communication network, first messages that identify actions to be performed by a plurality of healthcare devices, transmit the first messages to the plurality of healthcare devices over the communication network, receive second messages comprising information related to performing the actions from the plurality of healthcare devices over the communication network, determine whether at least one of the second messages indicates that a healthcare professional should be notified, transmit at least a portion of the at least one of the second messages to a user device of the healthcare professional over the communication network when the at least one of the second messages indicates that the healthcare professional should be notified, and store the first and second messages in a data store.

The disclosed subject matter also relates to a method for providing communication amongst devices and systems in a healthcare facility. The method includes transmitting, by a healthcare system, a first message comprising an order for a patient over a communication network to a healthcare device that is configured to facilitate providing healthcare to the patient. The method further includes receiving, by the healthcare system over the communication network and from the healthcare device, a second message that comprises information regarding the order being administered to the patient, the second message being received while the order is being administered to the patient. The method further includes receiving, by the healthcare system over the communication network and from the healthcare device, a third message that indicates that the order was administered to the patient by the healthcare device, wherein the third message comprises an identifier of a healthcare provider that assisted with administering the order to the patient and a time that the order was administered to the patient. The method further includes storing, by the healthcare system, an indication that the order was administered to the patient by the healthcare device, the time that the order was administered to the patient, and the identifier of the healthcare provider that assisted with administering the order to the patient.

The disclosed subject matter also relates to a method for providing communication amongst devices and systems in a healthcare facility. The method includes receiving, by a healthcare device over a communication network from a healthcare system, a first message comprising an order for a patient, wherein the healthcare device is configured to facilitate providing healthcare to the patient. The method further includes performing, by the healthcare device, an action associated with the order, and transmitting, by the healthcare device over the communication network and to the healthcare system, a third message that comprises information related to the action while the action is being performed.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment in which a healthcare communication system may be implemented in accordance with one or more embodiments.

FIG. 2 illustrates an example messaging architecture in which a healthcare communication system may be implemented in accordance with one or more embodiments.

FIG. 3 illustrates an alternative example messaging architecture in which a healthcare communication system may be implemented in accordance with one or more embodiments.

FIG. 4 illustrates a flow diagram of an example process for a control system in a healthcare communication system in accordance with one or more embodiments.

FIG. 5 illustrates a flow diagram of an example process for a healthcare system in a healthcare communication system in accordance with one or more embodiments.

FIG. 6 illustrates a flow diagram of an example process for a healthcare device in a healthcare communication system in accordance with one or more embodiments.

FIG. 7 illustrates an example user interface that may be implemented in a healthcare communication system in accordance with one or more embodiments.

FIG. 8 illustrates an example user interface that may be implemented in a healthcare communication system in accordance with one or more embodiments.

FIG. 9 illustrates an example user interface that may be implemented in a healthcare communication system in accordance with one or more embodiments.

FIG. 10 illustrates an example user interface that may be implemented in a healthcare communication system in accordance with one or more embodiments.

FIG. 11 conceptually illustrates an electronic system with which one or more embodiments of the subject technology may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced using one or more embodiments. In one or more instances, well-known structures and components are shown in block diagram form in order to avoid obscuring the concepts of the subject technology.

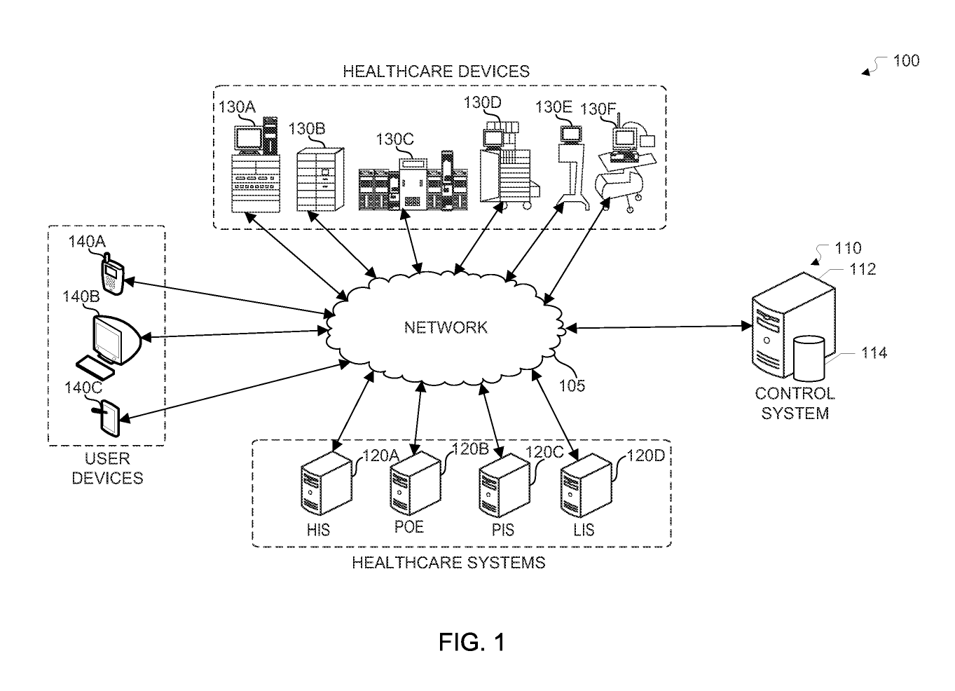

FIG. 1 illustrates an example network environment 100 in which a healthcare communication system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

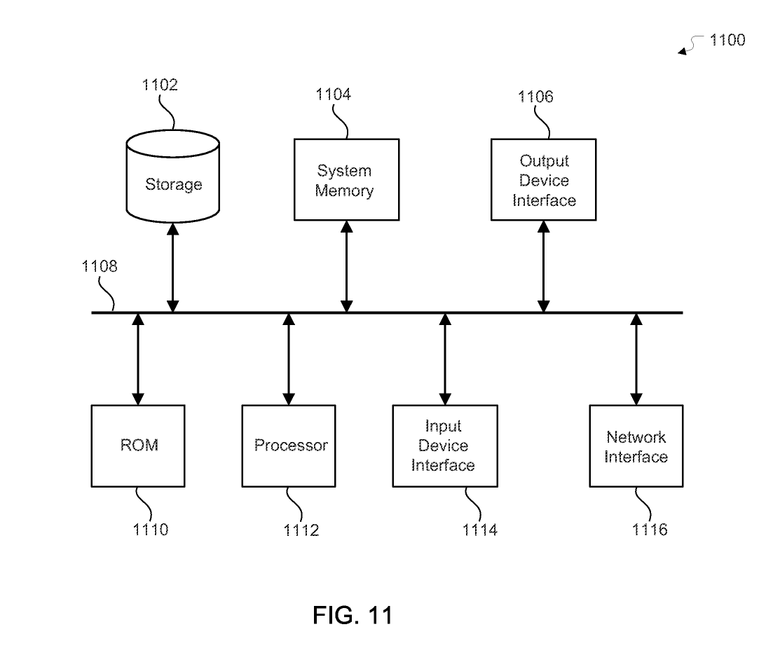

The network environment 100 includes a communication network 105, a control system 110, one or more healthcare systems 120A-D, one or more healthcare devices 130A-F, and one or more user devices 140A-C. The control system 110, healthcare systems 120A-D, healthcare devices 130A-F, and/or user devices 140A-C may be communicatively coupled to one another, such as by the network 105. In one or more embodiments, one or more of the control system 110, healthcare systems 120A-D, healthcare devices 130A-F, or user devices 140A-C may be directly coupled to one another. In addition, there may be a number of other devices connected to the network 105, such as additional healthcare systems, e.g. other clinical and/or logistical systems, additional healthcare devices, external systems, computing devices, mobile devices, etc. The control system 110, one or more healthcare systems 120A-D, one or more healthcare devices 130A-F, and/or one or more user devices 140A-C may be, or may include all or part of, the electronic system that is discussed further below with respect to FIG. 11.

The network 105 may be a public communication network (such as the Internet, cellular data network, dialup modems over a telephone network) or a private communications network (such as private local area network (“LAN”), leased lines). The network 105 may also include, but is not limited to, any one or more of the following network topologies, including a bus network, a star network, a ring network, a mesh network, a star-bus network, a tree or hierarchical network, and the like. The connections of the network 105 may be wired or wireless. For example, one or more of the control system 110, healthcare systems 120A-D, healthcare devices 130A-F, and/or user devices 140A-C may transmit wireless signals over the network 105, such as radio frequency (RF) signals, infrared (IR) signals, Bluetooth signals, or any other means capable of carrying information in a wireless manner between devices having appropriate transmitters and/or receivers.

The control system 110 may be a single computing device such as a computer server. Alternatively, the control system 110 may represent one or more computing devices (such as a cloud of computers and/or a distributed system) that are communicatively coupled, such as communicatively coupled over the network 105, and that collectively, or individually, perform one or more functions that can be performed server-side, such as receiving messages, transmitting messages, storing messaging, receiving control commands, providing user interfaces, transmitting notifications, etc. The one or more computing devices of the control system 110 may be geographically collocated and/or the one or more computing devices of the control system 110 may be disparately located. The control system 110 may be coupled with various databases, such as data store 114, storage services, or other computing devices. The control system 110, and the coupled databases, storage services, or other computing devices may be geographically collocated, or may be disparately located. In one or more embodiments, the control system 110 includes a processing device 112 and a data store 114. The processing device 112 executes computer instructions stored in the data store 114. In one or more embodiments, the data store 114 may store the computer instructions on non-transitory computer-readable medium.

The one or more healthcare systems 120A-D may be any systems that facilitate with providing healthcare, and/or provide healthcare. In FIG. 1, the healthcare system 120A is a hospital information system (HIS), the healthcare system 120B is a physician order entry (POE) system, the healthcare system 120C is a pharmacy information system (PIS), and the healthcare system 120D is a laboratory information system (LIS). The HIS may, for example, store information pertaining to the administration of the healthcare facility, such as a hospital. The HIS may provide, and/or may interface with a server that provides, billing and accounting functions. The POE system may be used, for example, by physicians to enter orders for patients, such as orders for medications to be administered to patients, that are then transmitted to the PIS.

The PIS may store, for example, information pertaining to a pharmacy of a healthcare facility, such as outstanding orders, filled orders, patient medical profiles/histories, etc. For example, the PIS may provide a library of drug allergies and adverse drug interactions against which each incoming order, or prescription, is checked as part of the order entering/drug dispensing process to identify possible allergies and adverse drug interactions and help in preventing administration of drugs to a patient where the patient might be injured by the prescribed course of therapy. Additionally, the PIS may check to determine if any therapies are being duplicated, such as where two or more drugs might be used to treat a diagnosed disease, whether they are synergistic or antagonistic, and whether the prescribed therapy should be modified accordingly. The LIS may store laboratory results, such as for tests performed to facilitate with providing healthcare to patients.

The healthcare devices 130A-F may include infusion devices, such as infusion pumps, drug delivery devices, dispensing devices, such as automated dispensing machines, smart beds, monitoring devices, respiratory devices, such as ventilators, waste devices, such as drug disposal devices, or generally any device that may facilitate with providing healthcare and/or may provide healthcare. The healthcare devices 130A-F may include a processor and memory. Alternatively, or in addition, the healthcare devices 130A-F may be communicatively coupled to a device that includes a processor and a memory, such as via a serial port.

For example the healthcare devices 130A-F may include Pyxis Medstations™ to store and dispense medications at the nurses stations, providing distributed access to the medications needed to treat patients, Pyxis® Anesthesia Systems to store and manage the medications used by anesthesiologists in the operating room, Pyxis SpecialtyStations™ to store specific medications and supplies in individual treatment areas, and Pyxis OncologyStations™ in oncology departments to manage the specialized and hazardous medications used to treat cancer. The healthcare devices 130A-F may also include waste devices that accept and store wasted medications, e.g. excess medications, from healthcare professionals and track the amount of medications wasted by healthcare professionals. In one or more embodiments, one or more of the waste devices may be a Pyxis EcoStation™ system.

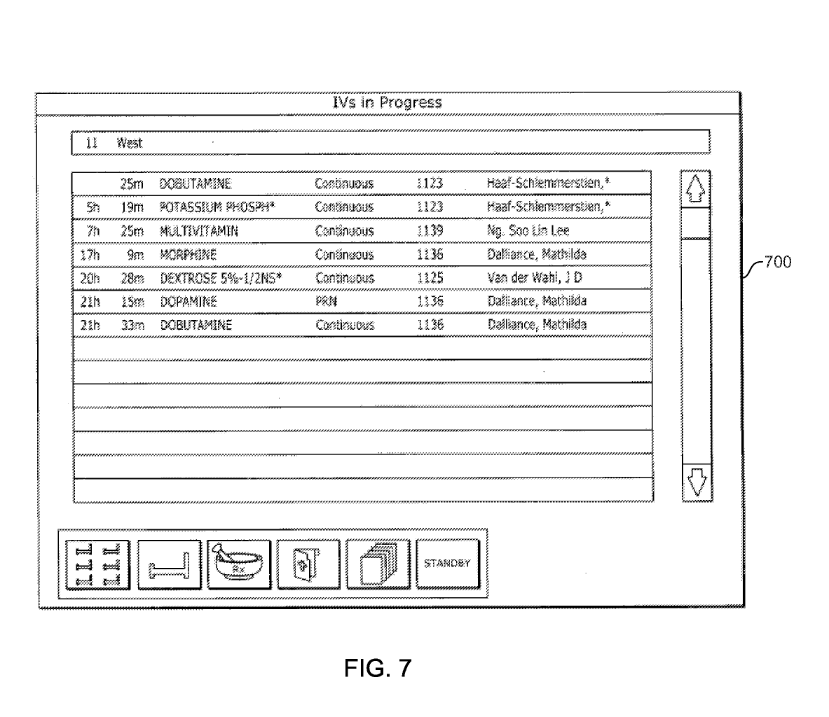

The user devices 140A-C may be electronic devices such as laptop or desktop computers, mobile phones, personal digital assistants (“PDAs”), portable media players, tablet computers, televisions or other displays, or other appropriate computing devices that can be used to display user interfaces that facilitate providing healthcare to patients, such as user interfaces that display information related to providing healthcare to patients and/or user interfaces that allow a healthcare professional, such as a doctor or nurse, access, create, and/or modify information related to providing healthcare to patients, such as modifying a schedule for preparing IVs in the PIS. Example user interfaces are discussed further below with respect to FIGS. 7-10. In the example of FIG. 1, the user device 140A is depicted as a mobile phone, the user device 140B is depicted as a desktop computer, and the user device 140C is depicted as a personal digital assistant (“PDA”), e.g. a tablet device. In one or more embodiments, the user devices 140A-C may include a processor and a memory.

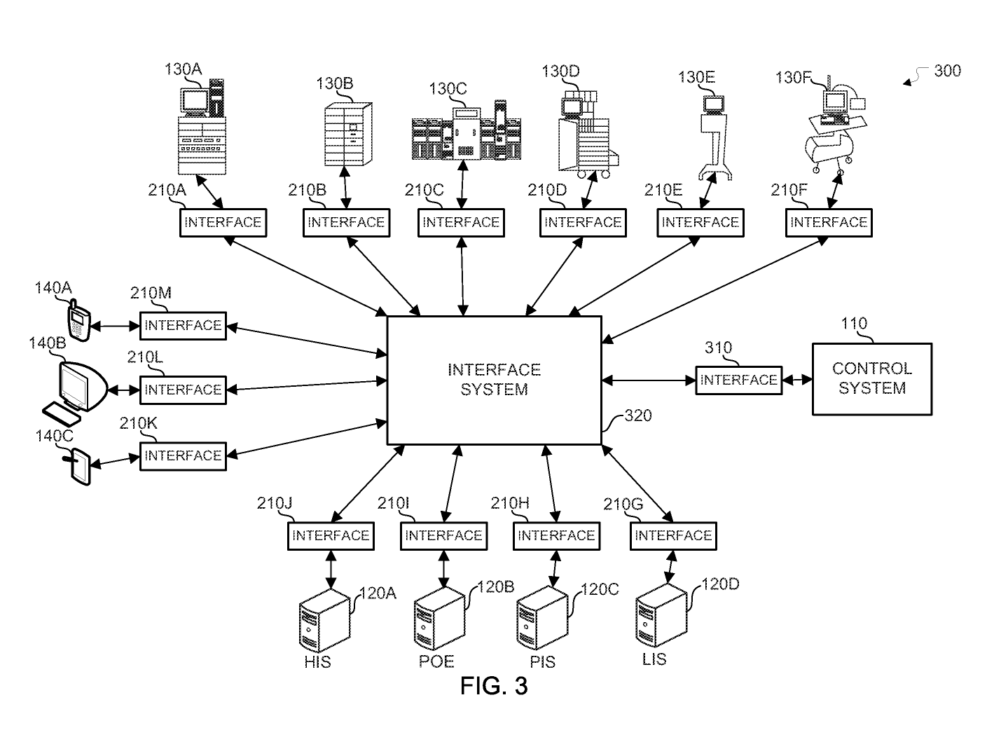

In operation, the control system 110, the healthcare systems 120A-D, the healthcare devices 130A-F, and/or the user devices 140A-C may transmit electronic data streams to one another over the network 105. The electronic data streams may include, for example, messages, and one or more of the messages may be referred to as a medical transaction carrier (MTC). The messages may relate to healthcare that is being facilitated by any of the healthcare systems 120A-D, the healthcare devices 130A-F, and/or the user devices 140A-C. For example, a message may include an order for a medication that is transmitted from a POE system to a PIS. In one or more embodiments, at least a portion of the message may later be transmitted by the PIS to a healthcare device 130A, such as to indicate that the ordered medication should be administered to the patient. Alternatively, or in addition, a message may relate to the progress of the delivery of medication, such as by one or more of the healthcare devices 130A-F. For example, the healthcare device 130A may transmit a message to the PIS that indicates the progress of delivering the medication by the healthcare device 130A to the patient. For example, the message may indicate that the healthcare device 130A has started delivering the medication, the healthcare device 130A has delivered an indicated amount of the medication, or the healthcare device 130A has completed the delivery of the medication. Example communication processes for transmitting messages and/or notifications amongst healthcare systems 120A-D, healthcare devices 130A-F, and/or user devices 140A-C are discussed further below with respect to FIGS. 3-5.

The control system 110 may provide user identity and notification systems. For example, the control system 110 may authenticate users and may control the access of a user, or a group of users. For example, a physician may be allowed to input orders into a POE system, while a nurse may only be allowed to view the orders in the POE system. Thus, the control system 110 may provide different views of information, e.g. information received from one or more of the healthcare systems 120A-D and/or the healthcare devices 130A-F, to different users based on the users' access privileges. The control system 110 may also provide user interfaces to users, such as via the user devices 140A-C, and may manage the users' interactions with the user interfaces. In one or more embodiments, the control system 110 may provide information for a patient to a user device 140A to be displayed on one of the user interfaces when the control system 110 determines that the user device 140A is within a proximity of the patient and/or within a proximity of one of the healthcare devices 130A-F that is providing, and/or facilitating with providing, healthcare to the patient. As previously discussed, example user interfaces are discussed further below with respect to FIGS. 7-10.

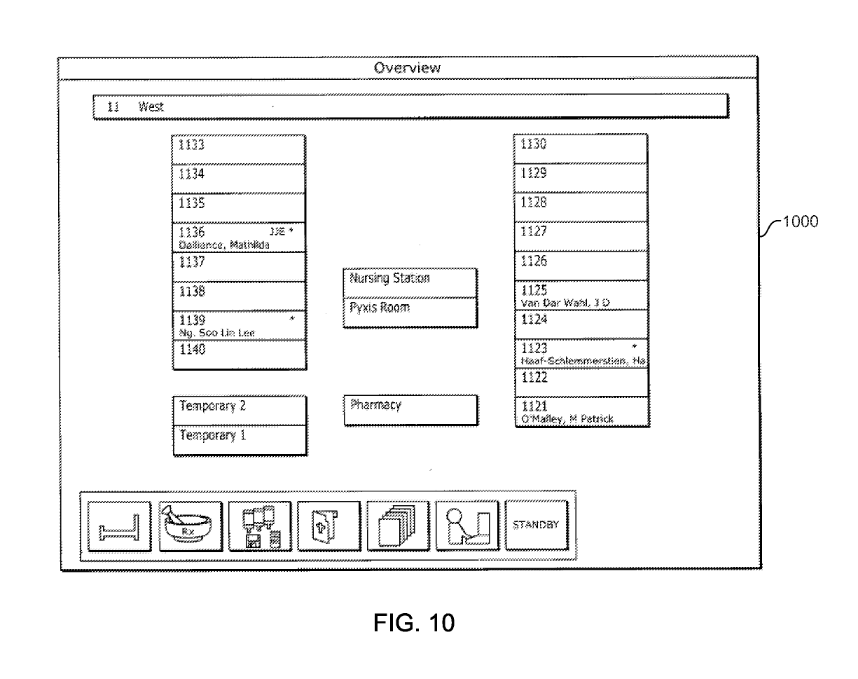

The control system 110 may also transmit notifications to one or more of the users, such as via the user devices 140A-C. For example, the control system 110 may transmit a notification to a user device 140A being accessed by a user, e.g. that the user has logged into, when the control system 110 determines that the user is within proximity of a patient who may need care, e.g. a patient that is receiving healthcare from one of the healthcare devices 130A-F that may be experiencing an error. In one or more embodiments, one or more of the notifications may be transmitted to the user devices 140A-C via a user interface. For example, the notification may cause a graphical indicator to be presented on a user interface being displayed on a user device 140A. Example user interfaces for presenting notifications are discussed further below with respect to FIGS. 7 and 10.

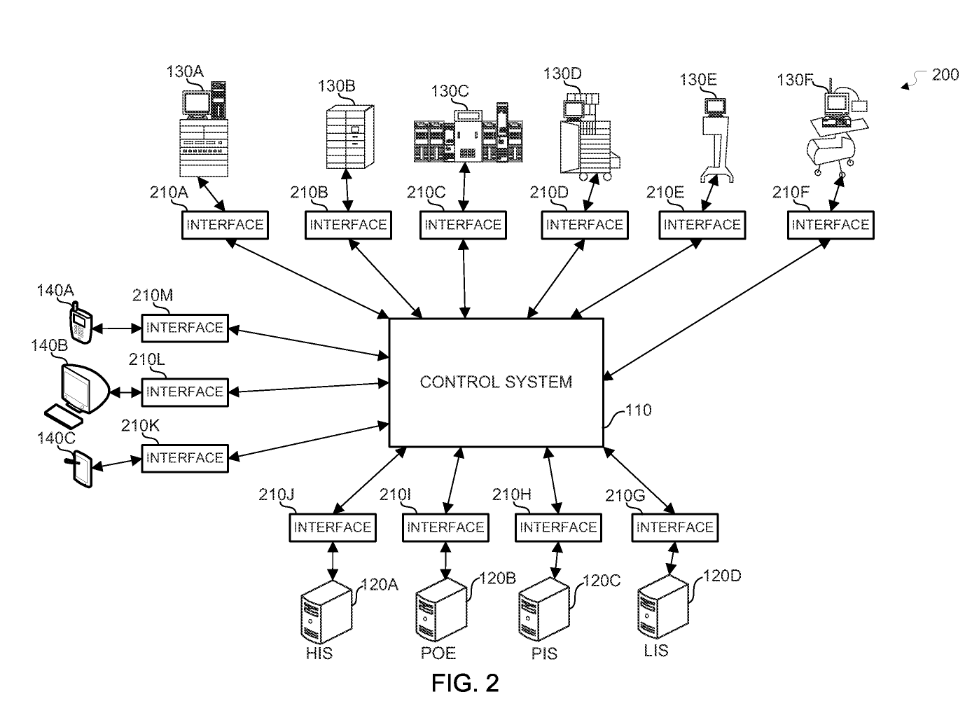

FIG. 2 illustrates an example messaging architecture 200 in which a healthcare communication system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The messaging architecture 200 includes the control system 110, one or more healthcare systems 120A-D, one or more healthcare devices 130A-F, and one or more user devices 140A-C. The control system 110, healthcare systems 120A-D, healthcare devices 130A-F, and user devices 140A-C may be communicably coupled to one another, such as by the network 105 shown in FIG. 1. The one or more healthcare systems 120A-D, one or more healthcare devices 130A-F, and one or more user devices 140A-C may include, and/or may be coupled to, interfaces 210A-M. The interfaces 210A-M may be adapters that are utilized by the one or more healthcare systems 120A-D, one or more healthcare devices 130A-F, and one or more user devices 140A-C to transmit messages to one another via the control system 110. In one or more embodiments, the interfaces 210A-M may be, and/or may include, the adapters described in U.S. patent application Ser. No. 13/421,776, entitled “Scalable Communication System,” filed on Mar. 15, 2012, which has been incorporated by reference in its entirety for all purposes.

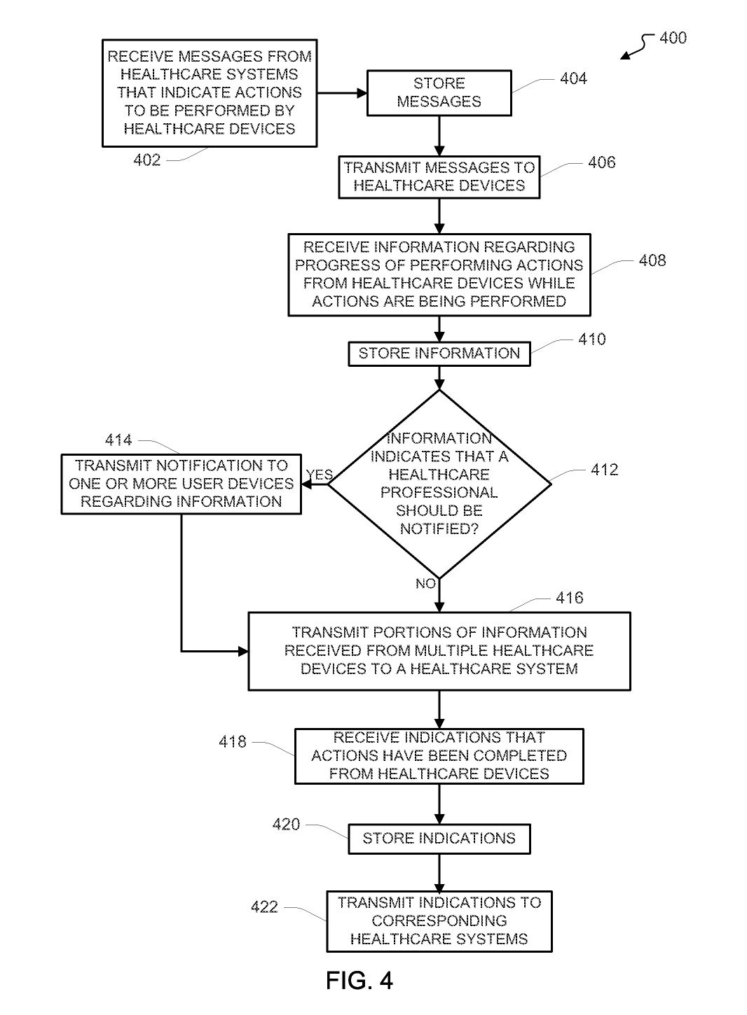

In one or more embodiments, messages transmitted by the healthcare systems 120A-D, the healthcare devices 130A-F, and/or the user devices 140A-C may be routed through the control system 110, e.g. via the interfaces 210A-M. For example, if a healthcare device 130A is sending a message to the healthcare system 120C, the healthcare device 130A may utilize the interface 210A to transmit the message to the control system 110, and the control system 110 may forward the message to the interface 210H, which provides the message to the healthcare system 120C. In one or more embodiments, the control system 110 may store the messages, such as in the data store 114, for further processing, such as to identify whether to transmit any information indicated in the messages to one or more of the user devices 140A-C, such as via a notification and/or via a user interface. An example communication process in which messages are routed through the control system 110 is discussed further below with respect to FIG. 4.

In one or more embodiments, the control system 110 may include an interface system that receives the messages from one or more of the healthcare systems 120A-D, the healthcare devices 130A-F, and/or the user devices 140A-C, via the interfaces 210A-M. The interface system may provide the interfaces 210A-M to the one or more of the healthcare systems 120A-D, the healthcare devices 130A-F, and the user devices 140A-C, and the one or more of the healthcare systems 120A-D, the healthcare devices 130A-F, and the user devices 140A-C may transmit messages to the interface system by utilizing the interfaces 210A-M.

In one or more embodiments, the interface system receives the messages in a first external format, e.g. a format native to the transmitting device and/or system, converts the messages into an internal messaging format, e.g. for processing and storing the messages, converts the messages into a second external format, e.g. a format native to the receiving device and/or system, and then transmits the messages in the second external format to the receiving device. In one or more embodiments, the first external format may be the same as the second external format. The interface system may be implemented as described, for example, in U.S. patent application Ser. No. 13/421,776, entitled “Scalable Communication System,” filed on Mar. 15, 2012, which has been incorporated by reference in its entirety for all purposes.

Alternatively, or in addition, one or more of the healthcare systems 120A-D, the healthcare devices 130A-F, and/or the user devices 140A-C may communicate with the control system 110 without utilizing the interfaces 210A-M. Alternatively, or in addition, one or more of the healthcare systems 120A-D, the healthcare devices 130A-F, and/or the user devices 140A-C may transmit messages directly to one another, e.g. without routing the messages through the control system 110.

FIG. 3 illustrates an alternative example messaging architecture 300 in which a healthcare communication system may be implemented in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The messaging architecture 300 includes an interface system 320, the control system 110, one or more healthcare systems 120A-D, one or more healthcare devices 130A-F, and one or more user devices 140A-C. The control system 110, interface system 320, healthcare systems 120A-D, healthcare devices 130A-F, and user devices 140A-C may be communicably coupled to one another, such as by the network 105 shown in FIG. 1. The one or more healthcare systems 120A-D, one or more healthcare devices 130A-F, and one or more user devices 140A-C may include, and/or may be coupled to, interfaces 210A-M. The control system 110 may include, and/or may be communicatively coupled to, the interface 310. The interfaces 210A-M, 310 may be adapters that are utilized by the one or more healthcare systems 120A-D, one or more healthcare devices 130A-F, one or more user devices 140A-C, and control system 110 to transmit messages to one another via the interface system 320. In one or more embodiments, the interfaces 210A-M, 310 may be, and/or may include, the adapters described in U.S. patent application Ser. No. 13/421,776, entitled “Scalable Communication System,” filed on Mar. 15, 2012, which was previously incorporated by reference in its entirety for all purposes.

In the messaging architecture 300, the interface system 320 may be separate from the control system 110, e.g. such that messages to/from the control system 110 are routed through the interface system 320. For example, the control system 110 and the interface system 320 may be separate devices, such as separate servers, or the control system 110 and the interface system 320 may be and/or may include distinct hardware on the same device. Alternatively, the control system 110 may receive messages directly from the interface system 320, e.g. without the use of the interface 310. Thus, in the messaging architecture 300, messages are routed through the interface system 320, rather than through the control system 110, as previously discussed with respect to FIG. 2.

Alternatively, or in addition, one or more of the healthcare systems 120A-D, the healthcare devices 130A-F, the user devices 140A-C, and/or the control system 110 may communicate with the interface system 320 without utilizing the interfaces 210A-M, 310. Alternatively, or in addition, one or more of the healthcare systems 120A-D, the healthcare devices 130A-F, the user devices 140A-C, and/or the control system 110 may transmit messages directly to one another, e.g. without routing the messages through the interface system 320.

FIG. 4 illustrates a flow diagram of an example process 400 for a control system in a healthcare communication system in accordance with one or more embodiments. For explanatory purposes, the example process 400 is described herein with reference to the control system 110 of the example network environment 100 of FIG. 1; however, the example process 400 is not limited to the control system 110 of the example network environment 100 of FIG. 1. For example, in one or more embodiments the example process 400 may be performed by the interface system 320 of FIG. 3. Further for explanatory purposes, the blocks of the example process 400 are described herein as occurring in serial fashion, or linearly. However, multiple blocks of the example process 400 may occur in parallel. In addition, the blocks of the example process 400 need not be performed in the order shown and/or one or more of the blocks of the example process 400 need not be performed.

In block 402, the control system 110 receives messages from one or more of the healthcare systems 120A-D over the network 105. The messages may indicate actions to be performed by, and/or with the facilitation of, one or more of the health care devices 130A-F. For example, a PIS may transmit an order that includes a medication to be administered to a patient to one of the healthcare devices 130A-F, such as an infusion pump and/or a drug dispensing device. The order may include one or more data items that relate to performing an action, such as information identifying the medication to be administered, the amount to be administered, an identifier of the patient receiving the medication, and/or an identifier of a healthcare professional that will be facilitating with administering the medication to the patient. In one or more embodiments, the actions may also include one or more of infusing a medication into a patient, such as by an infusion pump, a protocol for ventilating a patient, such as by a respirator or a ventilator, dispensing a drug for delivery to a patient, such as by an automated dispensing machine, monitoring a vital sign of a patient, such as by a health monitor, or generally any action that may be performed by, and/or with the facilitation of, one or more of the healthcare devices 130A-F.

In block 404, the control system 110 may store one or more of the messages, and/or a portion of one or more of the messages in a memory, such as in the data store 114. In one or more embodiments, the control system 110 may process the messages prior to storing the messages in the data store 114. For example, the control system 110 may process the messages to parse data items from the messages. In block 406, the control system 110 may transmit the messages to the recipient healthcare devices 130A-F, such as over the network 105. In one or more embodiments, the healthcare devices 130A-F may receive the messages and may initiate performing the actions identified in the messages.

In block 408, the control system 110 may receive messages from one or more of the healthcare devices 130A-F that include information regarding the progresses of performing the actions while the actions are being performed. For example, one or more of the healthcare devices 130A-F may periodically transmit messages to the control system 110 that include information that describes the progresses of performing the actions, such as indications that an action has been initiated, e.g. an infusion bag has been hung, an indication that an action is in progress, and/or an indication that the action is complete. In the example of a healthcare device 130A that includes an infusion pump, the infusion pump may periodically transmit messages to the control system 110 that indicate an amount of the medication that has been infused into the patient.

In block 410, the control system 110 stores the information regarding the progresses of performing the actions, such as in the data store 114. In one or more embodiments, the control system 110 may process the information prior to storing the information in the data store 114, such as to parse individual data items from the information. In block 412, the control system 110 processes the received information and determines whether any of the received information indicates that a healthcare professional should be notified. In one or more embodiments, the control system 110 may apply the received information, and/or information previously stored in the data store 114, against one or more rules, such as business rules, to determine whether a healthcare professional should be notified. For example, if information received from an infusion pump indicates that medication is being infused into a patient at a rate that contradicts the order rate, e.g. too quickly, the control system 110 may determine that a healthcare professional should be notified.

Alternatively, or in addition, if the received information indicates that a blood sample was obtained to determine a peak level of a drug in the blood but the drug has not finished being administered, the control system 110 may determine that a clinician should be notified that there is a timing issue. In another example, if the received information indicates that a blood thinner infusion was ordered to be held for two hours, and the infusion was not restarted at the end of the two hours, the control system 110 may determine that an appropriate healthcare professional should be notified that the infusion should be restarted. In one or more embodiments, if the received information indicates that lab results for a patient show an elevated lab test for an electrolyte, the control system 110 may determine that a healthcare professional should be alerted before removing a drug for administration to the patient that causes electrolytes to be elevated. Alternatively, or in addition, the control system 110 may prevent the healthcare professional from removing the drug from a dispensing machine. In one or more embodiments, if the received information indicates that insulin is being infused to a intensive care unit (ICU) patient, but blood testing has not been performed, or the patient's blood glucose level is very low but the insulin drip has not been adjusted, the control system 110 may determine that a healthcare professional should be notified.

If, in block 412, the control system 110 determines that received information indicates that a healthcare professional should be notified, the control system 110 moves to block 414. In block 414, the control system 110 transmits a notification regarding the received information to one or more of the user devices 140A-C. For example, the control system 110 may transmit a notification, such as a text message, an email, etc., to one or more of the user devices 140A-C, or the control system 110 may transmit a notification via a user interface, such as the user interfaces discussed below with respect to FIGS. 7 and 10. In one or more embodiments, the control system 110 may determine one or more user devices 140A-C to transmit the notification to, such as based on the type of users that are interacting with the user devices 140A-C, such as physicians, nurses, etc., the proximity of the user devices 140A-C to a location associated with the notification, such as a location of a healthcare device 130A that is associated with the notification. The notification may include one or more data items related to the received information, such as an identifier of a healthcare device 130A, an identifier of a patient, a reason why the notification is being sent, e.g. an error or an error log, or generally any data items related to the received information.

If, in block 412, the control system 110 determines that the received information does not indicate that a healthcare professional should be notified, the control system 110 moves to block 416. In block 416, the control system 110 transmits at least portions of information received from one or more healthcare devices 130A-F to one or more healthcare systems 120A-D. Alternatively, or in addition, the control system 110 may transmit at least portions of the received information to one or more of the user devices 140A-C. The control system 110 may transmit the information to the healthcare systems 120A-D for display while the actions are being performed. For example, the control system 110 may transmit information received from infusion pumps that indicates the status of in progress infusions to the PIS for display to one or more pharmacists. In one or more embodiments, the PIS may display the information via a user interface, such as the user interface discussed below with respect to FIG. 7.

In block 418, the control system 110 receives indications from one or more of the healthcare devices 130A-F that indicate that one or more of the actions have been completed. In block 420, the control system 110 stores the received indications in a memory, such as in the data store 114. In one or more embodiments, the control system 110 may process the indications prior to storing the indications in the data store 114, such as to parse individual data items from the indications. In block 422, the control system 110 transmits the indications to one or more of the healthcare systems 120A-D, such as the healthcare systems 120A-D that transmitted the messages that included the corresponding actions.

For explanatory purposes, the message passing in the example process 400 is described herein as being routed through the control system 110. However, in one or more embodiments the messages may be routed through the interface system 320 and/or the messages may be transmitted directly from the healthcare systems 130A-F to the healthcare devices 120A-D, and vice-versa.

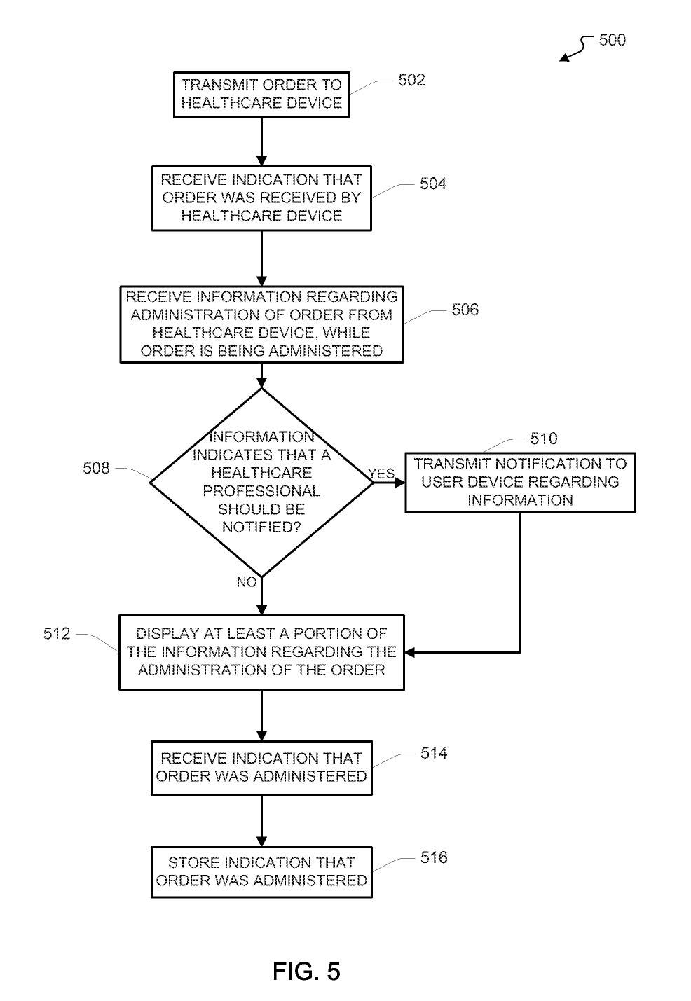

FIG. 5 illustrates a flow diagram of an example process 500 for a healthcare system in a healthcare communication system in accordance with one or more embodiments. For explanatory purposes, the example process 500 is described herein with reference to the example network environment 100 of FIG. 1; however, the example process 500 is not limited to the example network environment 100 of FIG. 1. Further for explanatory purposes, the blocks of the example process 500 are described herein as occurring in serial fashion, or linearly. However, multiple blocks of the example process 500 may occur in parallel. In addition, the blocks of the example process 500 need not be performed in the order shown and/or one or more of the blocks of the example process 500 need not be performed.

In block 502, one of the healthcare systems 120A-D, such as the PIS, transmits an order to a healthcare device 130A, such as over the network 105. In one or more embodiments, the order may be an order for a medication to be administered to a patient. In one or more embodiments, the order may include one or more data items that relate to administering the order, such as information identifying the medication being administered, the amount of the medication to be administered, an identifier of the patient receiving the medication, an identifier of a healthcare professional that will be facilitating with administering the medication, etc. In block 504, the healthcare system 120C receives an indication, over the network 105, that the order was received by the healthcare device 130A. In block 506, the healthcare system 120C receives, over the network 105 and from the healthcare device 130A, information regarding the administration of the order, while the order is being administered.

In block 508, the healthcare system 120C processes the received information and determines whether any of the received information indicates that a healthcare professional should be notified. In one or more embodiments, the healthcare system may apply the received information, and/or information previously stored in a data store, against one or more rules, such as business rules, to determine whether a healthcare professional should be notified. For example, if information received from an infusion pump indicates that medication is being infused into a patient at a rate that contradicts a rate indicated in the order, the healthcare system 120C may determine that a healthcare professional should be notified.

If, in block 508, the healthcare system 120C determines that received information indicates that a healthcare professional should be notified, the healthcare system 120C moves to block 510. In block 510, the healthcare system 120C transmits a notification regarding the received information to one or more of the user devices 140A-C. For example, the healthcare system 120C may transmit a notification, such as a text message, an email, etc., to one or more of the user devices 140A-C, and/or the healthcare system 120C may transmit a notification via a user interface, such as the user interfaces discussed below with respect to FIGS. 7 and 10. In one or more embodiments, the healthcare system 120C may determine one or more user devices 140A-C to transmit the notification to, such as based on the type of users that are interacting with the user devices 140A-C, such as physicians, nurses, etc., the proximity of the user devices 140A-C to a location associated with the notification, such as a location of a healthcare device 130A that is associated with the notification. The notification may include one or more data items related to the received information, such as an identifier of a healthcare device 130A, an identifier of a patient, a reason why the notification is being sent, e.g. an error or an error log, or generally any data items related to the received information.

If, in block 508, the healthcare system 120C determines that the information does not indicate that a healthcare professional should be notified, the healthcare system 120C moves to block 512. In block 512, the healthcare system 120C displays at least a portion of the information regarding the administration of the order, such as while the order is being administered. For example, the healthcare system 120C may display the information via a user interface to one or more pharmacists, such as the user interface discussed below with respect to FIG. 7. The pharmacists may use the information to schedule the preparation of medications and/or the healthcare system 120C may reschedule the preparation of medications based at least in part on the information.

In block 514, the healthcare system 120C receives an indication, over the network 105 and from the healthcare device 130A, that the order was administered. In one or more embodiments, the healthcare system 120C may display information pertaining to the indication, such as to the one or more pharmacists, and/or the information may be used for scheduling the preparation of medications, such as additional medication that corresponds to the order, e.g. a refill of the order. In block 516, the healthcare system 120C may store the indication in a memory, such as a data store.

For explanatory purposes, the transmissions of the process 500 are described as being transmitted over the network 105 directly to/from one or more of the healthcare systems 120A-D, healthcare devices 130A-F, and/or user devices 140A-C. However, one or more of the transmissions described in the example process 500 may be routed through one or more of the control system 110 and/or the interface system 320.

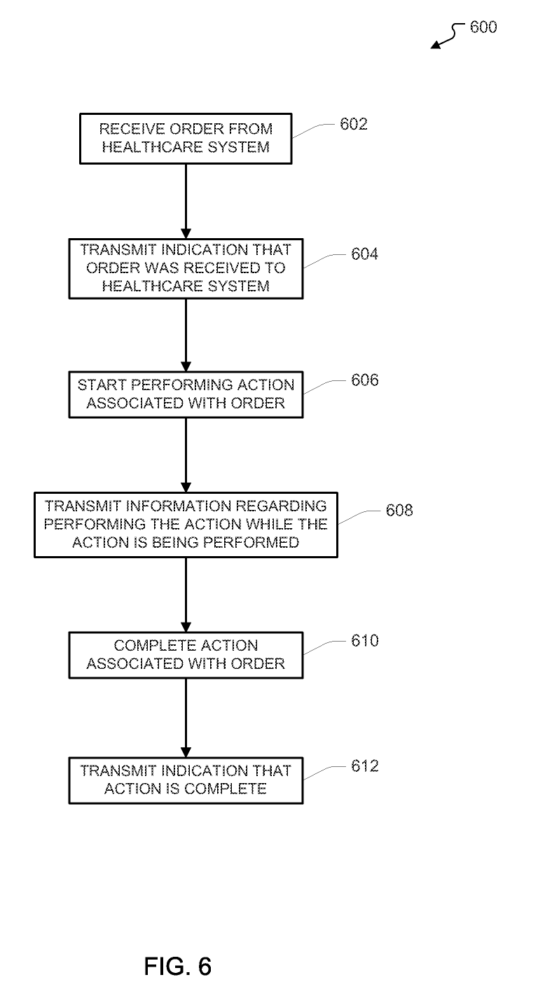

FIG. 6 illustrates a flow diagram of an example process 600 for a healthcare device in a healthcare communication system in accordance with one or more embodiments. For explanatory purposes, the example process 600 is described herein with reference to the example network environment 100 of FIG. 1; however, the example process 600 is not limited to the example network environment 100 of FIG. 1. Further for explanatory purposes, the blocks of the example process 600 are described herein as occurring in serial fashion, or linearly. However, multiple blocks of the example process 600 may occur in parallel. In addition, the blocks of the example process 600 need not be performed in the order shown and/or one or more of the blocks of the example process 600 need not be performed.

In block 602, one of the healthcare devices 130A-F, such as the healthcare device 130A, may receive an order from one of the healthcare systems 120A-D, such as the healthcare system 120C. In one or more embodiments, the order may be an order for a medication to be administered to a patient. In one or more embodiments, the order may include one or more data items that relate to administering the order, such as information identifying the medication being administered, the amount of the medication to be administered, an identifier of the patient receiving the medication, an identifier of a healthcare professional that will be facilitating with administering the medication, etc.

In block 604, the healthcare device 130A may transmit an indication, over the network 105 to the healthcare system 120C, that the order was received. In block 606, the healthcare device 130A may begin performing an action associated with the order, such as an action related to administering the order. For example, the healthcare device 130A may begin an infusion, initiate a respiratory protocol, dispense a drug, or generally may initiate any action that may be performed by, or with facilitation of, the healthcare device 130A.

In block 608, the healthcare device 130A may transmit, over the network 105 and to the healthcare system 120C, information related to performing the action, while the action is being performed. For example, the healthcare device 130A may transmit an amount of a medication that has been administered to a patient, or generally any information that may relate to performing an action. In block 610, the healthcare device 130A may complete the action, such as by completing an infusion. In block 612, the healthcare device 130A may transmit an indication, over the network 105 to the healthcare system 120C, that the action is complete.

FIG. 7 illustrates an example user interface 700 that may be implemented in a healthcare communication system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 700 may display information relating to in-progress actions being performed by one or more of the healthcare devices 130A-F, such as medical orders being administered. For example, the user interface 700 displays a report of IVs that are being administered by, and/or with the facilitation of, one or more of the healthcare devices 130A-F. In one or more embodiments, the administrations of medical orders that will terminate within a preselected time period may be distinguished on the user interface 700 from other administrations by color highlighting or other means. The user interface 700 may further display the time remaining, medication, and patient name, as well as buttons for program control. In one or more embodiments, the user interface 700 may display pending infusions or infusions scheduled to begin within a preselected time period.

In operation, the user interface 700 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare devices 130A-F related to actions being performed by the one or more healthcare devices 130A-F. The control system 110 may parse the received messages to obtain the information displayed on the user interface 700, and/or the received messages may be displayed on the user interface 700.

The information displayed on the user interface 700 may be updated in real-time as the control system 110 and/or one or more of the healthcare systems 120A-D receives messages from the healthcare devices 130A-F, such as while orders are being administered to patients. In one or more embodiments, the user interface 700 may be used to modify the preparation of medications, such as by scheduling and/or rescheduling, the preparation of medications.

In one or more embodiments, the user interface 700 may also display notifications, and/or alerts, such as when a healthcare professional is associated with a user device 140A that is displaying the user interface 700. For example, in the user interface 700, the notifications may be indicated by an asterisk (“*”). In one or more embodiments, the healthcare professional may select information that is displayed with an asterisk, such as by touching or clicking on the information, to receive additional information regarding the notification. In one or more embodiments, one or more of the alerts and/or notifications may only be displayed when the healthcare professional is proximally located to the one or more healthcare devices 130A-F to which the alerts and/or notifications pertain.

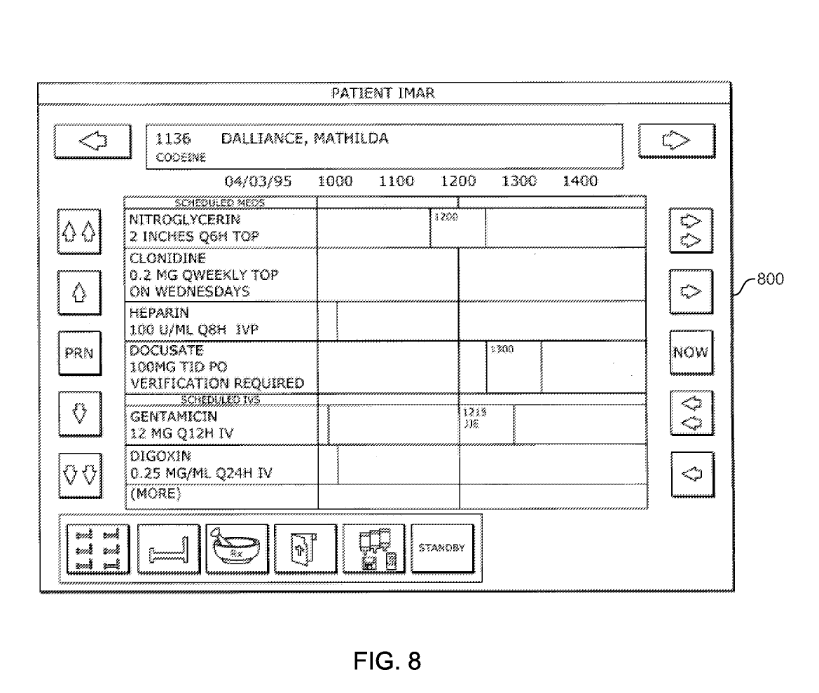

FIG. 8 illustrates an example user interface 800 that may be implemented in a healthcare communication system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 800 may display information relating to a patient, such as information received from one or more of the healthcare systems 120A-C and/or one or more of the healthcare devices 130A-F. The displayed information may include information related to medications and/or infusions, such as IVs, that are scheduled for the patient, and the information may be received from the healthcare system 120C. The information may further include information related to medications and/or infusions that are being administered to the patient, and this information may be received from one or more of the healthcare devices 130A-F. For example, the user interface 800 displays information related to scheduled medications and IVs for an identified patient. In one or more embodiments, the user interface 800 may be color coded to indicate the status and schedule of each medication administration. For example, a medication delivery window extending from thirty minutes prior and thirty minutes after the scheduled administration time may be indicated by a yellow band on the user interface 800.

In operation, the user interface 800 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare systems 120A-D, and/or one or more of the healthcare devices 130A-F, that relate to a patient. The control system 110 may parse the received messages to obtain the information displayed on the user interface 800, and/or the received messages may be displayed on the user interface 800.

In one or more embodiments, the user interface 800 may automatically be provided to the user device 140A of a healthcare professional when the healthcare professional is located within a proximity of the patient and/or within a proximity of one or more healthcare devices 130A-F that are providing, and/or facilitating with providing, healthcare to the patient. Thus, the user device 140A of a healthcare professional may automatically display, and/or prepare for display, information related to an identified patient when the healthcare professional is within proximity of the patient, such as at the bedside of the patient. Accordingly, the information displayed on the user interface 800 may change as the healthcare professional moves throughout the healthcare facility.

In one or more embodiments, the user device 140A may receive information for displaying the user interface 800 when the healthcare professional is proximally located to the patient, but the user device 140A may not display the user interface 800 until prompted by the healthcare professional. For example, the user device 140A may receive the information for displaying the user interface 800 and may then display a notification to the healthcare professional indicating that the information is available, and requesting whether the healthcare professional would like the user interface 800 to be displayed on the user device 140A and/or on a display or monitor proximally located to the user device 140A.

The information displayed on the user interface 800 may be updated in real-time as the control system 110 and/or one or more of the healthcare systems 120A-D receives messages from the healthcare devices 130A-F, such as while orders are being administered to the patient. In one or more embodiments, the user interface 800 may be used to schedule and/or reschedule, the preparation of medications, such as by the healthcare system 120C.

The information displayed on the user interface 800 may be updated in real-time as the control system 110 and/or one or more of the healthcare systems 120A-D receives messages from the healthcare devices 130A-F and/or the healthcare systems 120A-D, such as while orders are being administered to patients, while orders are being prepared for administration to patients, and/or when orders are received from a physician order entry system. In one or more embodiments, the user interface 800 may be used to verify the administration of orders, such as a healthcare professional verifying that a medication scheduled for administration and/or a medication being administered coincides with the ordered medication. In one or more embodiments, a healthcare professional may be able to select, such as touch or click on, an order and the user interface 800 may display a picture of the medication being administered, or about to be administered.

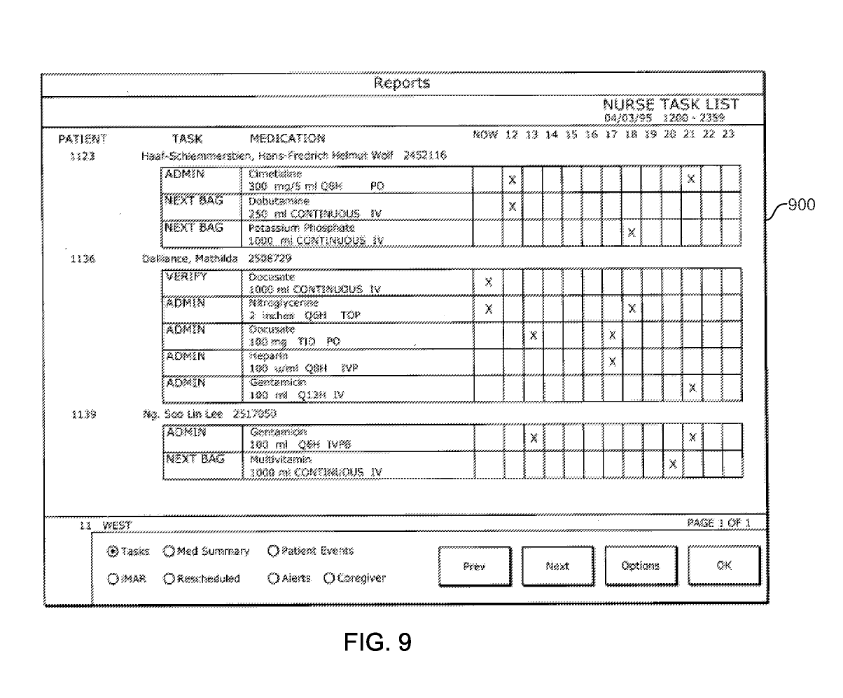

FIG. 9 illustrates an example user interface 900 that may be implemented in a healthcare communication system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 900 may display information to an identified healthcare professional that relates to in-progress actions being performed by, and/or with the facilitation of, one or more of the healthcare devices 130A-F, and for which the healthcare professional is facilitating and/or monitoring. The user interface 900 may also display information to the identified healthcare professional that relates to future actions to be performed by, and/or with the facilitation of, one or more of the healthcare devices 130A-F, and for which the healthcare professional is facilitating and/or monitoring. Alternatively, or in addition, the user interface 900 may display information related to in-progress or future actions that are being performed proximally to the user device 140A, and a healthcare professional accessing the user device 140A. For example, the user interface 900 displays a report of IVs that are being administered by one or more of the healthcare devices 130A-F. In one or more embodiments, the user interface 900 may include scheduling of medication administrations to ensure proper medication of the patient while distributing the workload over a period of time to ensure that all medication is given promptly.

In operation, the user interface 900 may be provided by the control system 110, and/or one or more of the healthcare systems 120A-D, for display on a screen, such as a screen of one or more of a user devices 140A being accessed by a healthcare professional, and/or a screen or monitor associated with one or more of the healthcare systems 120A-D. For example, the control system 110 may receive messages from one or more of the healthcare systems 120A-D, and/or one or more of the healthcare devices 130A-F, that relate to in-progress actions and/or future actions that are being performed with the facilitation of the healthcare professional, and/or that are being performed proximally to the healthcare professional, as indicated by the location of the user device 140A. The control system 110 may parse the received messages to obtain the information displayed on the user interface 900, and/or the received messages may be displayed on the user interface 900.

In one or more embodiments, the user interface 900 may automatically be provided to the user device 140A of a healthcare professional when the healthcare professional is located within a proximity of the patient and/or within a proximity of one or more healthcare devices 130A-F that are providing, and/or facilitating with providing, healthcare to one or more patients. Thus, the user device 140A of a healthcare professional may automatically display, and/or prepare for display, information related to in-progress and/or future actions that are being performed, and/or will be performed, proximally to the location of the healthcare professional. Accordingly, the information displayed on the user interface 900 may change as the healthcare professional moves throughout the healthcare facility.

In one or more embodiments, the user device 140A may receive information for displaying the user interface 900 when the healthcare professional is proximally located to in-progress, or future actions, but the user device 140A may not display the user interface 900 until prompted by the healthcare professional. For example, the user device 140A may receive the information for displaying the user interface 900 and may then display a notification to the healthcare professional indicating that the information is available, and requesting whether the healthcare professional would like the user interface 900 to be displayed on the user device 140A and/or on a display or monitor proximally located to the user device 140A.

The information displayed on the user interface 900 may be updated in real-time as the control system 110 and/or one or more of the healthcare systems 120A-D receives messages from the healthcare devices 130A-F, such as while orders are being administered to patients. In one or more embodiments, the user interface 900 may be used to verify the administration of orders, such as a healthcare professional verifying that a medication scheduled for administration and/or a medication being administered coincides with the ordered medication. In one or more embodiments, a healthcare professional may be able to select, such as touch or click on, an order and the user interface 900 may display a picture of the medication being administered, or about to be administered.

FIG. 10 illustrates an example user interface 1000 that may be implemented in a healthcare communication system in accordance with one or more embodiments. Not all of the depicted components may be required, however, and one or more embodiments may include additional components not shown in the figure. Variations in the arrangement and type of the components may be made without departing from the spirit or scope of the claims as set forth herein. Additional, different or fewer components may be provided.

The user interface 1000 may display information relating to patients in a healthcare facility and/or in an area of a healthcare facility, such as alerts or notifications related to healthcare being administered to patients in a healthcare facility. For example, the user interface 1000 may display a graphical representation of each room in an area of the healthcare facility, the name of the patient occupying each room, if any, and any alerts or notifications that apply to any of the displayed patients. In the user interface 1000, an alert or notification is indicated by an asterisk (“*”); however, any other graphical indicator may be used to indicate an alert and/or notification.

In operation, the user interface 1000 may be provided by the control system 110, and/or one or more of the healthcare systems 120A-D, for display on a screen, such as a screen of one or more of the user devices 140A-C, and/or a screen or monitor associated with one or more of the healthcare systems 120A-D. For example, the control system 110 may receive messages from one or more of the healthcare devices 130A-F related to actions being performed by the or more healthcare devices 130A-F. The control system 110 may parse the received messages to determine whether any alerts and/or notifications should be displayed via the user interface 1000, such as whether any discrepancies and/or errors are identified from the received messages.

In one or more embodiments, the user interface 1000 may automatically be provided to the user device 140A of a healthcare professional when the healthcare professional is located within a proximity of the area of the healthcare facility represented on the user interface 1000. Thus, the user device 140A of a healthcare professional may automatically display, and/or prepare for display, the user interface 1000 when a healthcare professional is proximally located to the represented area. Accordingly, the information displayed on the user interface 1000 may change as the healthcare professional moves throughout the healthcare facility.

In one or more embodiments, the user device 140A may receive information for displaying the user interface 1000 when the healthcare professional is located proximally to the represented area, but the user device 140A may not display the user interface 1000 until prompted by the healthcare professional. For example, the user device 140A may receive the information for displaying the user interface 1000 and may then display a notification to the healthcare professional indicating that the information is available, and requesting whether the healthcare professional would like the user interface 1000 to be displayed on the user device 140A and/or on a display or monitor proximally located to the user device 140A.

The information displayed on the user interface 1000 may be updated in real-time as the control system 110 and/or one or more of the healthcare systems 120A-D receives messages from the healthcare devices 130A-F, such as while orders are being administered to patients.

In one or more embodiments, the user interface 1000 may display the status of each patient's infusion, and when an alert occurs, the box representing the patient's room flashes red to attract attention to the alert. Accordingly, a healthcare professional accessing the user interface 1000 may be able to quickly and easily identify the patient from the user interface, such as at a nursing station, and take appropriate action to address the condition causing the alert. In one or more embodiments, certain alerts that have been identified as particularly important events may be displayed on multiple screens throughout the healthcare facility, such as in the pharmacy.

In one or more embodiments, the user interface 1000 may also be used for updating administrative records of the healthcare facility. For example, if a patient changes rooms, a healthcare professional can transmit a notification of the room change to the control system 110 by selecting the patient's name, and dragging that patient to the new room. In addition, the user interface 1000 may be updated to reflect the room change.

FIG. 11 conceptually illustrates electronic system 1100 with which one or more embodiments of the subject technology may be implemented. Electronic system 1100, for example, can be, or can include, the control system 110, the interface system 320, one or more of the healthcare systems 120A-D, one or more of the healthcare devices 130A-F, one or more of the user devices 140A-C, a desktop computer, a laptop computer, a tablet computer, a phone, a personal digital assistant (PDA), and/or generally any electronic device that transmits signals over a network. Such an electronic system includes various types of computer readable media and interfaces for various other types of computer readable media. Electronic system 1100 includes bus 1108, processing unit(s) 1112, system memory 1104, read-only memory (ROM) 1110, permanent storage device 1102, input device interface 1114, output device interface 1106, and network interface 1116, or subsets and variations thereof.

Bus 1108 collectively represents all system, peripheral, and chipset buses that communicatively connect the numerous internal devices of electronic system 1100. In one or more embodiments, bus 1108 communicatively connects processing unit(s) 1112 with ROM 1110, system memory 1104, and permanent storage device 1102. From these various memory units, processing unit(s) 1112 retrieves instructions to execute and data to process in order to execute the processes of the subject disclosure. The processing unit(s) can be a single processor or a multi-core processor in different embodiments.

ROM 1110 stores static data and instructions that are needed by processing unit(s) 1112 and other modules of the electronic system. Permanent storage device 1102, on the other hand, is a read-and-write memory device. This device is a non-volatile memory unit that stores instructions and data even when electronic system 1100 is off. One or more embodiments of the subject disclosure use a mass-storage device (such as a magnetic or optical disk and its corresponding disk drive) as permanent storage device 1102.

Other embodiments use a removable storage device (such as a floppy disk, flash drive, and its corresponding disk drive) as permanent storage device 1102. Like permanent storage device 1102, system memory 1104 is a read-and-write memory device. However, unlike storage device 1102, system memory 1104 is a volatile read-and-write memory, such as random access memory. System memory 1104 stores any of the instructions and data that processing unit(s) 1112 needs at runtime. In one or more embodiments, the processes of the subject disclosure are stored in system memory 1104, permanent storage device 1102, and/or ROM 1110. From these various memory units, processing unit(s) 1112 retrieves instructions to execute and data to process in order to execute the processes of one or more embodiments.

Bus 1108 also connects to input and output device interfaces 1114 and 1106. Input device interface 1114 enables a user to communicate information and select commands to the electronic system. Input devices used with input device interface 1114 include, for example, alphanumeric keyboards and pointing devices (also called “cursor control devices”). Output device interface 1106 enables, for example, the display of images generated by electronic system 1100. Output devices used with output device interface 1106 include, for example, printers and display devices, such as a liquid crystal display (LCD), a light emitting diode (LED) display, an organic light emitting diode (OLED) display, a flexible display, a flat panel display, a solid state display, a projector, or any other device for outputting information.

One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

Finally, as shown in FIG. 11, bus 1108 also couples electronic system 1100 to a network (not shown) through network interface 1116. In this manner, the computer can be a part of a network of computers (such as a local area network (“LAN”), a wide area network (“WAN”), or an Intranet, or a network of networks, such as the Internet. Any or all components of electronic system 1100 can be used in conjunction with the subject disclosure.

Many of the above-described features and applications may be implemented as software processes that are specified as a set of instructions recorded on a computer readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra density optical discs, any other optical or magnetic media, and floppy disks. In one or more embodiments, the computer readable media does not include carrier waves and electronic signals passing wirelessly or over wired connections, or any other ephemeral signals. For example, the computer readable media may be entirely restricted to tangible, physical objects that store information in a form that is readable by a computer. In one or more embodiments, the computer readable media is non-transitory computer readable media, computer readable storage media, or non-transitory computer readable storage media.

In one or more embodiments, a computer program product (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A communication system, comprising:
a communication network;
a plurality of healthcare systems communicatively coupled to the communication network, wherein at least one of the plurality of healthcare systems is configured to transmit first messages comprising orders for a plurality of patients over the communication network to a plurality of healthcare devices;
the plurality of healthcare devices communicatively coupled to the communication network, each of the plurality of healthcare devices being configured to:
facilitate providing healthcare to at least one of the plurality of patients;
transmit, to the at least one of the plurality of healthcare systems over the communication network and in response to receiving the first messages, second messages that indicate that the first messages comprising the orders have been received,
transmit, to the at least one of the plurality of healthcare systems over the communication network and while the orders are being administered, third messages that each comprise information relating to a progress of administering one of the orders, and
transmit, to the at least one of the plurality of healthcare systems over the communication network, fourth messages that indicate that the orders were administered to the patients.

2. The communication system of claim 1, further comprising:
a control system communicatively coupled to the communication network.

3. The communication system of claim 2, wherein the first messages are transmitted from the at least one of the plurality of healthcare systems to the plurality of healthcare devices through the control system over the communication network and the second, third, and fourth messages are transmitted from the plurality of healthcare devices to the at least one of the plurality of healthcare systems through the control system over the communication network.

4. The communication system of claim 3, wherein the plurality of healthcare systems and the plurality of healthcare devices are in communication with the control system via a plurality of interfaces.

5. The communication system of claim 2, further comprising an interface system communicatively coupled to the communication network, wherein the first messages are transmitted from the at least one of the plurality of healthcare systems to the plurality of healthcare devices through the interface system over the communication network and the second, third, and fourth messages are transmitted from the plurality of healthcare devices to the at least one of the plurality of healthcare systems through the interface system over the communication network.

6. The communication system of claim 5, wherein the plurality of healthcare systems and the plurality of healthcare devices are in communication with the interface system via a plurality of interfaces.

7. The communication system of claim 6, wherein the interface system comprises a coordination engine that is configured to convert the first, second, third, and fourth messages into an internal message format, upon receipt of the first, second, third, and fourth messages.

8. The communication system of claim 2, further comprising:
a plurality of user devices, communicatively coupled to the communication network, that are configured to display information received from the control system over the communication network, wherein the control system is further configured to transmit the information to the plurality of user devices, the information being related to at least one of the first, second, third, or fourth messages that are transmitted through the control system.

9. The communication system of claim 8, wherein the information comprises at least a portion of one of the third messages and the information is transmitted to the plurality of user devices while the one of the orders corresponding to the one of the third messages is being administered.

10. The communication system of claim 9, wherein the control system is further configured to transmit a notification to the at least one of the plurality of healthcare systems or at least one of the plurality of user devices, in response to receiving one of the fourth messages.

11. The communication system of claim 8, wherein the control system is further configured to receive notifications from the plurality of healthcare systems and provide the notifications to the plurality of user devices.

12. The communication system of claim 8, wherein the control system is configured to provide a first information to a first user device of the plurality of user devices and a second information to a second user device of the plurality of user devices, wherein the first information is different than the second information.

13. The communication system of claim 12, wherein the first user device is being accessed by a physician while the second user device is being accessed by a nurse.

14. The communication system of claim 13, wherein the first information is related to preparing medications or administering the medications.

15. The communication system of claim 1, wherein one of the third messages comprises vital sign information for one of the plurality of patients and one of the fourth messages comprises a time that a medication of one of the orders was administered to one of the plurality of patients and an indication of a healthcare provider that facilitated with delivering the medication.

16. The communication system of claim 1, wherein at least one of the plurality of healthcare devices comprises at least one of an infusion device or a smart bed.

17. The communication system of claim 16, wherein one of the first messages comprises an indication of a medication for delivery to one of the plurality of patients and at least one of an infusion delivery protocol, a medication limit, or a time based medication constraint.

18. The communication system of claim 1, wherein at least one of the plurality of healthcare systems comprises a pharmacy information system, a hospital information system, or a physician order entry system.

19. The communication system of claim 1, wherein at least one of the plurality of healthcare systems comprises a laboratory information system.

20. The communication system of claim 1, wherein at least one of the plurality of healthcare devices comprises a patient feeding device, a drug delivery device, a patient monitoring device, or a respiratory device.

21. The communication system of claim 20, wherein the drug delivery device comprises a drug dispensing device and the respiratory device comprises a ventilator.

22. A control system, comprising:
one or more processors; and
a memory including instructions that, when executed by the one or more processors, cause the one or more processors to:
receive, from a plurality of healthcare systems over a communication network, first messages that identify actions to be performed by a plurality of healthcare devices;
transmit the first messages to the plurality of healthcare devices over the communication network;
receive second messages comprising information related to performing the actions from the plurality of healthcare devices over the communication network;
determine whether at least one of the second messages indicates that a healthcare professional should be notified;
transmit at least a portion of the at least one of the second messages to a user device of the healthcare professional over the communication network when the at least one of the second messages indicates that the healthcare professional should be notified; and
store the first and second messages in a data store.

23. The control system of claim 22, wherein the instructions, when executed by the one or more processors, further cause the one or more processors to:
transmit the second messages to the plurality of healthcare systems over the communication network;
receive third messages that indicate that the actions have been completed from the plurality of healthcare devices over the communication network; and
transmit the third messages to the plurality of healthcare systems over the communication network.

24. The control system of claim 23, wherein at least one of the second messages indicates that the first message was received by one of the plurality of healthcare devices and another of the second messages indicates that the action is being performed by the one of the plurality of healthcare devices, the another of the second messages being received while the action is being performed by the one of the plurality of healthcare devices.

25. The control system of claim 22, wherein the at least one of the second messages indicates that the healthcare professional should be notified when the at least one of the second messages indicates that administration of an order is behind schedule, that additional medication is required, or that a discrepancy exists between at least one of the first messages and at least one of the second messages.

26. The control system of claim 22, wherein at least one of the actions comprises infusing a medication by one of the plurality of healthcare devices, delivering a medication by one of the plurality of healthcare devices, or monitoring at least one of a vital sign or a respiratory status by one of the plurality of healthcare devices.

27. A method for providing communication amongst devices and systems in a healthcare facility, the method comprising:
transmitting, by a healthcare system, a first message comprising an order for a patient over a communication network to a healthcare device that is configured to facilitate providing healthcare to the patient;
receiving, by the healthcare system over the communication network and from the healthcare device, a second message that comprises information regarding the order being administered to the patient, the second message being received while the order is being administered to the patient;
receiving, by the healthcare system over the communication network and from the healthcare device, a third message that indicates that the order was administered to the patient by the healthcare device, wherein the third message comprises an identifier of a healthcare provider that assisted with administering the order to the patient and a time that the order was administered to the patient; and
storing, by the healthcare system, an indication that the order was administered to the patient by the healthcare device, the time that the order was administered to the patient, and the identifier of the healthcare provider that assisted with administering the order to the patient.

28. The method of claim 27, further comprising:
displaying, by the healthcare system, at least a portion of the information of the second message while the order is being administered to the patient.

29. A method for providing communication amongst devices and systems in a healthcare facility, the method comprising:
receiving, by a healthcare device over a communication network from a healthcare system, a first message comprising an order for a patient, wherein the healthcare device is configured to facilitate providing healthcare to the patient;
performing, by the healthcare device, an action associated with the order; and
transmitting, by the healthcare device over the communication network and to the healthcare system, a third message that comprises information related to the action while the action is being performed.

30. The method of claim 29, wherein the first message comprises an indication of a medication for delivery to the patient and at least one of an infusion delivery protocol, a medication limit, or a time based medication constraint.
